(19) United States
(12) Patent Application Publication
(10) Pub. No.: US 2013/0262207 A1
(43) Pub. Date: Oct. 3, 2013

(54) SYSTEM AND METHOD FOR UTILIZING A BUSINESS CARD DIRECTORY SYSTEM

(71) Applicant: Brendon Miskell, Sydney (AU)

(72) Inventor: Brendon Miskell, Sydney (AU)

(21) Appl. No.: 13/906,134

(22) Filed: May 30, 2013

Related U.S. Application Data
(63) Continuation-in-part of application No. 13/181,480, filed on Jul. 12, 2011.

(30) Foreign Application Priority Data
Oct. 19, 2010 (AU) 2010/904,661

(51) Int. Cl. G06Q 50/00

(52) U.S. Cl. CPC G06Q 50/01; G06Q 30/0214
USPC 705/14.16; 705/319

(57) ABSTRACT

A business card directory system to provide a user access to a data network that includes a server computing device that includes a user interface module and a database and an input device that is coupleable to the server computing device. The system also includes a processor system with a user interface module that is adaptive to receive the one or more pieces of data provided on one or more traditional business cards and a computer program product stored on a computer usable medium that operates in combination with the processor system and a user interface module adapted to receive the one or more pieces of data and to present a web user interface and a n online social media network and an online business network. There is also a method for utilizing a business card directory system.

This continuation-in-part application claims priority to U.S. non-provisional application 13/181,480 filed on Jul. 12, 2011 that claims priority to Australian Provisional Application 2010/904,661 filed on 19 Oct. 2010, the entire disclosure of which is incorporated by reference.

### FIELD OF THE INVENTION

The present invention relates to directories and in particular to business directories. More specifically, the present invention is a business card directory system and method for utilizing the business card directory system.

### BACKGROUND OF THE INVENTION

Traditional business cards are typically stored in a card holder, which is usually located on an owner's desk. Details associated with traditional business cards are typically maintained in personal organizers, spreadsheets or the like. Traditional business cards can be easily lost, damaged or even destroyed.

### SUMMARY OF THE INVENTION

The present invention is a business card directory system for providing a user access to a data network, the business card directory system includes a server computing device with a user interface module and a database. The server computing device is adapted to receive one or more pieces of data provided on one or more traditional business cards. The server computing device includes a user interface module adapted to receive the one or more pieces of data. The present invention also includes a method for utilizing the business card directory system.

It is an object of the present invention to provide a business card directory system for providing a user access to a data network, the business card directory system includes a server computing device with a user interface module and a database. The server computing device is adapted to provide a user interface module for viewing one or more eCards.

It is an object of the present invention to provide an input device that is coupleable to the server computing device. The input device can input one or more traditional business cards, from which one or more pieces of data provided on the one or more traditional business cards are generated. Additionally, the one or more pieces of data are downloaded to the server computing device over a data network such as the Internet. The server computing device also includes a user interface module for presenting a web user interface.

It is an object of the present invention to provide a server computing device that is adapted to generate a user eCard from data provided on one or more traditional business cards, which can be stored in a database. The user eCard can be made available online or offline to efficiently match the user to searched business services.

It is an object of the present invention to provide a server computing device that is adapted to generate one or more eCards from data provided on one or more corresponding traditional business cards, which can be stored in a database. The eCard can be provided restricted availability online or offline to a user associated with presenting one or more corresponding traditional business cards. The one or more eCards are generated by a user and are each associated with a respective third party business eCard and are privately accessible to the user. The one or more third party eCards reside in a virtual eCard folder.

It is an object of the present invention to provide data associated with an eCard folder including one or more associated eCards that can be downloaded from a server computing device and stored on a mobile interface device where offline access to the eCard folder can be provided by the mobile interface device.

It is an object of the present invention to provide a method for utilizing a business card directory system, the method includes the steps of accessing an online registration page, registering a first member, generating a corresponding user record, storing the corresponding member record to a database, receiving data provided on a first member business card, generating a corresponding eCard record associated with the corresponding first member record, storing the eCard record to the database and receiving business attributes associated with the first member, updating the first member record, storing the member record to the database.

It is an object of the present invention to provide a processor system for providing a business card directory system, the processor system includes a user interface module, the processor system is adapted to receive one or more pieces of data provided on one or more traditional business cards and present a user interface module for accessing the business card directory system.

It is an object of the present invention to provide a user access interface for a processor system, the processor system being adapted to provide a business card directory system, the processor system being coupleable to a database where one or more user records reside including data provided on one or more traditional business cards. The user access interface includes a control program adapted to present a user access interface for accessing the database and presenting a business card directory system.

It is an object of the present invention to provide a method for utilizing a business card directory system utilizing a processor and a database.

It is an object of the present invention to provide a computer program product stored on a computer usable medium, the computer program product is adapted to provide a method for utilizing a business card directory system.

It is an object of the present invention to provide a computer program product stored on a computer usable medium, the computer program product is adapted to provide a user access interface for a processor and a database, the processor and the database being adapted to receive one or more pieces of data provided on one or more traditional business cards, the processor being coupleable to the database where a plurality of one or more user records reside each associated with the one or more pieces of data, the computer program product includes a computer readable program for providing a business card directory system.

### BRIEF DESCRIPTION OF THE DRAWINGS

The present invention will be described by way of exemplary embodiments, but not limitations, illustrated in the accompanying drawings in which like references denote similar elements, and in which:

FIG. 1A illustrates a diagram of a business card directory system to provide a user access to a data network, in accordance with one embodiment of the present invention.

FIG. 1B illustrates a diagram of the business card directory system with a plurality of input devices, in accordance with one embodiment of the present invention.

FIG. 2A illustrates a diagram of a business card directory system to provide a user access to a data network, in accordance with one embodiment of the present invention.

FIG. 2B illustrates a diagram of the business card directory system with a plurality of interface devices, in accordance with one embodiment of the present invention.

FIG. 3 illustrates a diagram of a user interface, in accordance with one embodiment of the present invention.

FIG. 4 illustrates a diagram of a distributed business card directory system to provide a user access to a data network, in accordance with one embodiment of the present invention.

FIG. 5 illustrates a flowchart of a method for utilizing a business card directory system, in accordance with one embodiment of the present invention.

FIG. 6 illustrates a home page screenshot of a business card directory system, in accordance with one embodiment of the present invention.

### DETAILED DESCRIPTION OF ILLUSTRATIVE EMBODIMENTS

Various objects of the illustrative embodiments will be described utilizing terms commonly employed by those skilled in the art to convey the substance of their work to others skilled in the art. However, it will be apparent to those skilled in the art that the present invention may be practiced with only some of the described objects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

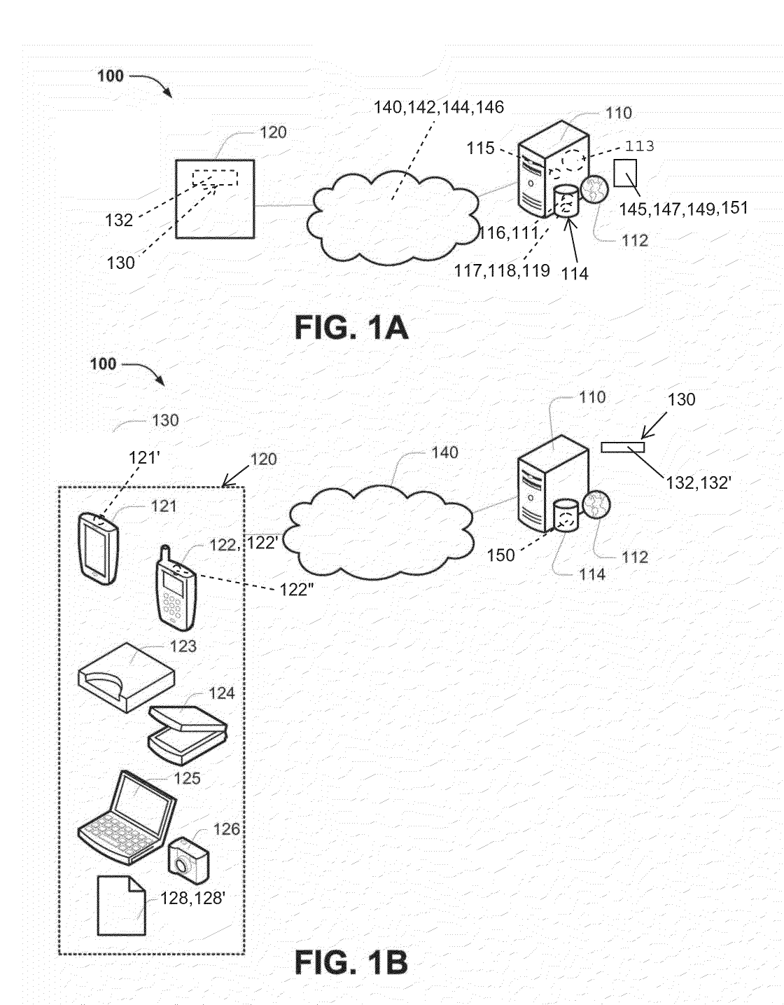

FIG. 1A illustrates a diagram of a business card directory system 100 to provide a user access to a data network 140, in accordance with one embodiment of the present invention.

The business card directory system 100 includes a server computing device 110 with a user interface module 112, a processor system 113, a database 114 and an input device 120. The input device 120 inputs one or more pieces of data 132 from one or more traditional business cards 130. One or more traditional business cards 130 are defined as one or more business cards made of paper, plastic or other suitable synthetic or natural material such as cotton. The one or more pieces of data 132 can be transmitted over the data network 140 to the server computing device 110 with the user interface module 112. The user interface module 112 is adaptive to receive the one or more pieces of data 132 provided on one or more traditional business cards 130. The data network 140 can be the Internet 142, a local area network or LAN 144, a wide area network WAN 146 or other suitable data network. The server computing device 110 generates a user eCard 115, which can be stored in the database 114. The user eCard 115 can be made available online or offline to efficiently match the user to one or more business services and business connections associated with one or more other users. The business card directory system 100 includes a private memory system 116 and a public memory system 118 that both reside on the database 114. The private memory system 116 and the public memory system 118 allow the users to separately store and prioritize the one or more pieces of data 132 obtained from the one or more traditional business cards 130. The business card directory system 100 also includes a computer program product 145 stored on a computer usable medium 147 that operates in combination with the processor system 113 and a referral rewards program 149 that allows the user to gain one or more reward points 151 based on one or more new users joining the business card directory system 100.

A user can submit one or more third party traditional business cards 117, each of which can be converted into a third party eCard 119 that will reside on the public memory system 118 of the database 114, and is also made accessible to the user. The one or more third party traditional business cards 117 can be viewed by the user and can be used to contact an associated third party business. The user may use a user eCard 115 to initiate an invitation to a third party business to become an additional user of the business card directory system 100. Typically, user eCards 115 provided by a user remain privately accessible to the user, typically maintained in an eCard folder 111 that resides on the private memory system 116 of the database 114.

FIG. 1B illustrates a diagram of the business card directory system 100 with a plurality of input devices 120, in accordance with one embodiment of the present invention.

FIG. 1B illustrates and describes a business card directory system 100 for providing user access to a data network 140 that is similar to the business card directory system 100 and the input device 120 illustrated and described in FIG. 1A and its description. The business card directory system 100 illustrated and described in FIG. 1A and its description includes the input device 120 that can include a smart phone 121 (typically with a built-in camera 121′), a mobile phone 122 or a cell phone 122′ (typically with a built-in camera 122″), a business card scanner 123, a paper or photo card scanner 124, a laptop computer 125, a digital camera 126 or other suitable input device. A previous electronic image 128 or a previous electronic file 128′ of the one or more traditional business cards 130 can also be input into the business card directory system 100. One or more software applications 150 can be provided to process the one or more pieces of data 132 (typically one or more pieces of image data 132′) and submitting the one or more pieces of data 132 to a server computing device 110.

The one or more traditional business cards 130 can be forwarded to a third party service facility having an input device 120 for enabling the one or more traditional business cards 130 to be submitted. The one or more traditional business cards 130 and any data associated with the one or more traditional business cards 130 can be scanned into the server computing device 110 to be transmitted, exchanged and stored as desired by a user.

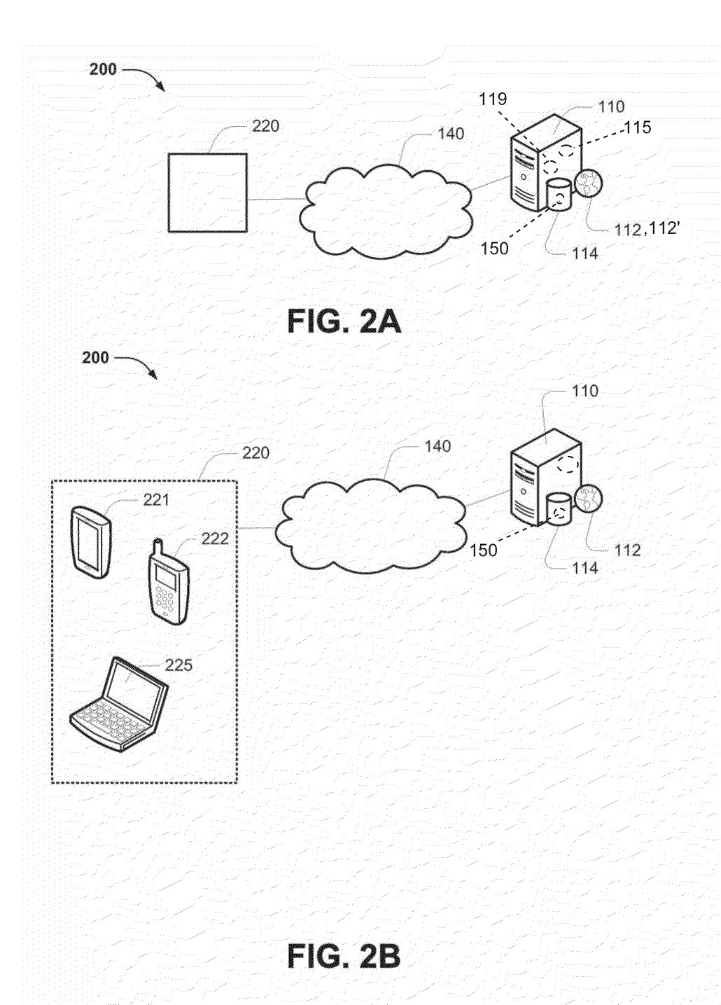

FIG. 2A illustrates a diagram of a business card directory system 200 to provide a user access to a data network 140, in accordance with one embodiment of the present invention. The business card directory system 200 includes a server computing device 110 with a user interface module 112 and a database 114 that is similar to the business card directory system 100, the server computing device 110 with a user interface module 112 and the database 114 illustrated and described in FIG. 1A and its description. The interface device 220 is in communication with the server computing device 110 over a data network 140. A user can view private eCards 119 and user eCards 115 submitted by other users typically made publically available. Access to an eCard folder 111 having one or more eCards 115 , 119 can be provided by the server computing device 110.

A user interface module 112 is typically in the form of a web interface 112′ presented by the server computing device 110. A web interface 112′ is well suited to be utilized by one or more mobile or handheld devices 120 previously described and illustrated in FIG. 1B and its description (i.e., utilizing one or more style sheets). Alternatively, the user interface module 112 can be a custom interface presented by the interface device 220 coupleable to a database 114.

One or more software applications 150 can be provided for displaying a user interface module 112, the one or more software applications 150 can make one or more requests to the server computing device 110 via a user interface module 112 or t o directly access the database 114. The user can be authenticated prior to accessing the user interface module 112 with any suitable authenticating device or authenticating method.

FIG. 2B illustrates a diagram of the business card directory system 200 with a plurality of interface devices 220, in accordance with one embodiment of the present invention. FIG. 2B illustrates a business card directory system 200 for providing user access to a data network 140 that includes an interface device 220 that can include a smart phone 221, a mobile phone or a cell phone 222, and/or laptop computer 225. One or more software applications 150 can reside on the database 114 and can be provided for presenting or displaying a user interface module 112.

In an embodiment of the present invention, one or more business attributes associated with one or more user records can address any one or more of business or service classification type business expertise key words provided on the business benefits to customers, business types of interest business services required (i.e., in the next six months), one or more geographical locations (i.e., region, suburb, post code), or one or more associated names (i.e., business name, business owner's name, employee name). These one or more attributes can assist with matching one or more business functions, which can be used in presenting search results, or when presenting targeting advertising. These one or more attributes can be used in developing a business network of one or more related or associated businesses or business types.

In an embodiment of the present invention, one or more business attributes associated with one or more user records can include one or more search records or searchable records specifying, one or more business names, one or more owner names, one or more employee names, one or more associated industry categories, one or more business types, one or more geographic locations, one or more postcodes and/or one or more states. The search record can be compared against one or more search parameters provided by another user searching the business directory. If the search results in a match for a user search record, one or more eCards can be displayed typically as an electronic image of a traditional business card. One or more registered users provide data provided on the one or more traditional business cards, which can be compared when conducting a user search. The one or more eCards can be collected and/or swapped by or between users. One or more collated eCards can also be associated with a user record as a virtual eCard folder.

In an embodiment of the present invention, data associated with an eCard folder having one or more associated eCards can be downloaded and stored on a mobile interface device, which can enable offline access to an eCard folder.

In an embodiment of the present invention, a business card directory system provides a user access to a business network that includes one or more business attributes obtained from one or more traditional business cards. The business network can utilize the Internet, typically via a web enabled user interface and a personal mobile communication service, typically via a mobile phone, a smart phone, a portable digital assistant, or the like.

In an embodiment of the present invention, an online or offline service can be provided via a user interface presented by an electronic system (i.e. a mobile phone), where a user of the service can submit data provided on one or more traditional business cards. The service can then generate a corresponding eCard, which can be stored in a database.

In an embodiment of the present invention, one or more eCards can be made available to efficiently match one or more user tones, one or more business services and/or provide one or more business connections associated with one or more other users. One or more eCards can be swapped with, and stored by, one or more other users. This provides a business matching and business networking tool utilizing one or more traditional business cards. The business card directory system can provide a business to business network. A business can include one or more sole traders, one or more companies, one or more organizations, one or more associations, one or more departments, one or more clubs, one or more teams or one or more groups of people. The business card directory interface or method for utilizing can be included in a social networking interface as well.

In an embodiment of the present invention, one or more eCards can originate and be converted from one or more traditional business cards, the one or more converted eCards can enable matching of one or more businesses and business services. This further enables creation of a networked business environment.

In an embodiment of the present invention, a system and method for utilizing a business card directory system enables one or more business to business or B2B and business to consumer or B2C directories t o be applied to one or more B2B or B2C networks. One or more eCards can be used as an electronic matching tool within a network environment. One or more data parameters associated with the one or more business eCards are searchable, and one or more users or one or more businesses can be matched by the business card directory system. The one or more eCards are also made available online or offline.

In an embodiment of the present invention, one or more electronic business eCards can be produced, from one or more traditional business cards or the like, by obtaining one or more attributes from one or more traditional business cards and one or more associating respective data parameters, and a user is enabled to search or match one or more eCards utilizing a user selected search criteria within a networked business environment.

In an embodiment of the present invention, a user is enabled to generate one or more pieces of data provided on the one or more traditional business cards, by scanning or photographing the one or more traditional business cards. A mobile phone application can facilitate capturing image data provided on the one or more traditional business cards and submitting the image data to an eCard server for storing in a database. Also, a traditional business card scanning device can be used to generate image data provided on one or more traditional business cards and to submit, with or without use of an externally coupled processor device, the image data to an eCard Server for storing in a database. One or more eCards can be made available to one or more authorized business and/or community users. One or more attributes associated with the one or more eCards can be obtained from image data provided on the one or more traditional business cards or added by a corresponding user with a user interface.

In an embodiment of the present invention, data provided on one or more traditional business cards can be provided as image data prepared electronically. A business owner or a traditional business card printer can provide electronic image data being a proof image of one or more traditional business cards for generating one or more pieces of data provided on one or more traditional business cards. A server computing device can enable a user to generate one or more traditional business card proof images, the one or more proof images can be used to generate one or more pieces of data provided on one or more traditional business cards, and may be forwarded to a traditional business card printer for preparing one or more corresponding traditional business cards. A business matching process enables one or more users, such as one or more business and/or community or non-business owner's or clients, to search for one or more business services within a business network identified by one or more eCard attributes obtained from the original one or more traditional business cards.

In an embodiment of the present invention, an advantage offered to one or more users over a traditional business network is that a user eCard can be swapped, exchanged or stored (i.e. with an electronic eCard folder). Based on user eCard data and one or more related attributes, the one or more users can be matched with other users seeking a desired business type or a business profile. The eCard can include a digital representation of the one or more traditional business cards. By including one or more traditional business card image data, one or more eCard attributes can include one or more business logos and one or more trademarks presented on the one or more traditional business cards, which presents one or more advantages over a text business profiling system or method.

In an embodiment of the present invention, a user who joins a business network can provide one or more traditional business cards, which are scanned or digitally photographed to provide one or more image data. The one or more image data are converted into one or more digital records or one or more eCards and are stored in a database. The one or more eCards are associated with a user record. The one or more eCards can be used to connect with another existing user and storing or associating the one or more existing user eCards with the user record. One or more business connections can be made on user assigned regions (i.e., local, country, global), which can be specified by a level of membership.

In an embodiment of the present invention, a user can further specify one or more preferences regarding one or more types or classes of other users that the user may be interested in networking with. These preferences can be maintained in a user record. This enables the server computing device to search for relevant other users, and present corresponding details or one or more eCards for acceptance by the user and/or storage within an eCard folder. The search can be undertaken automatically and results are displayed to a user at log-in, or e-mailed at one or more selected intervals.

In an embodiment of the present invention, the server computing device can include a match module or a search module for automatically or selectively undertaking one or more searches of an eCard repository with results displayed to a user. A business network can be facilitated by linking a plurality of users together, typically as an outcome of a search result identifying relevant other users. One or more special offers may be sent to one or more users, over one or more mobile devices and one or more e-mails, based on results of an automated matching tool. For example, a community user can ask in their registration form “What services are you in the market for over the next 3 months?” where the user can select a refrigerator, an oven, a white good or other suitable item. A business user in the relevant geographical region supplies relevant services is alerted, and a special offer can be sent to the community user, providing a permission-based marketing system, and an offer is sent with consent being obtained first. Multiple business users in the same geographical region may be auctioned an exclusive listing of a specific business listing in that business region. A pay per click style campaign can be introduced. A user can negotiate a lower membership fee in return for paying a performance based fee, such as payment each time another user clicks on their eCard like an advertisement.

In an embodiment of the present invention, a search can be conducted, either on an eCard folder or a publicly available eCard directory based on predetermined search parameters typically stored in a search record.

In an embodiment of the present invention, a user interface can include advertising with a plurality of other users. One or more system selected advertising words and advertising banners may be included in, or presented to, a user interface. By incorporating one or more virtual traditional business cards or one or more eCards, upon a user conducting a search, one or more results can be displayed on one or more traditional business cards. A paid user or a premium user can be entitled to a priority location in a search result. One or more search results can be ordered according to the number of other businesses introduced by the searched business providing preference to people building the business network. The search results can be ordered according to an established relevance ranking. It is also possible to randomly sort search results such that there is no perceived preference.

In an embodiment of the present invention, a search of relevant businesses by a user can be undertaken and one or more results are presented as one or more traditional business card type representations. A search is typically conducted based on a geographic location (i.e., postcode), a business type, one or more keywords, a user name and a business name.

In an embodiment of the present invention, a server computing device can track one or more entities of one or more prospective leads or searching users. The server computing device is enabled and all users are typically registered, to identify the user that reviewed an eCard or a business profile. A user can have access to an identity of one or more other users who access or view the user's eCard. A user can also be provided with a report such as a daily, a monthly, a quarterly or an annual report, for enabling the user to follow-up leads. This can assist in establishing an estimate for a cost per lead. Typically, the user can access this lead information in a private log-in area or in a physical report if paying for one or more offline marketing services.

In an embodiment of the present invention, once a search result is displayed in one or more business eCards, a user can select and save one or more eCards to their eCard folder. Typically, a user initiates a search by providing one or more search properties, the server computing device then presents one or more eCards that match one or more search parameters, and the user can then select one or more eCards from the results to be added to the user eCard folder. While undertaking a search, one or more relevant eCards of interest can also be displayed, for example, as advertising. The relevance of one or more other businesses can be assessed based on a user's one or more previous searches, or one or more predefined preferences. By selecting one or more eCards, it can also be possible to launch an associated web-page or initiate an e-mail editor for communicating with a respective business organization.

In an embodiment of the present invention, by including an imaged eCard, it is possible to present an ad-like image for a business, without requiring substantial additional effort from the business. In an embodiment of the present invention, a referral reward program can be incorporated, and the user that introduces a new business that becomes a user can be rewarded through a reward contribution, typically with one or more reward points.

In an embodiment of the present invention, one or more privately provided business details (i.e., one or more traditional business cards) presented to the directory and stored in a user profile can be considered a first introduction and the user receives one or more points if the corresponding business later becomes a user.

In an embodiment of the present invention, one or more reward points can be equated to a dollar amount or a physical equivalent and a user can transact with another user utilizing the one or more points. Similarly in an international implementation, an exchange rate can be established between one or more different regions. A business or community user can also get one or more reward points for referring subsequent business or community users.

In an embodiment of the present invention, one or more reward points can be continually awarded to a user for referring another user, as a percentage of a membership fee or equivalent points while both users maintain a paid membership.

In an embodiment of the present invention, a discount voucher can also be presented by one or more users to other one or more business users or consumer users. One or more products and services can be purchased utilizing one or more points or a currency transaction. Typically, the discount voucher can be printed and used by a consumer at the corresponding business. The discount voucher can also be presented to a user based on one or more preferences identified in their corresponding user profile.

In an embodiment of the present invention, one or more accumulated reward points can be recycled back to one or more services or goods offered by one or more registered users, or a business community. Reward points can be redeemed as a complete or a partial payment for one or more goods or services.

In an embodiment of the present invention, one or more traditional business cards are a primary business introduction tool. However, there are limitations in a method for distribution, requiring physical communication of the card typically by, or on behalf of, a business owner. These one or more traditional business cards can be lost, or discarded. These one or more traditional business cards are typically stored in a traditional business card holder, which is only accessible to the possessor of the one or more cards. These limitations can be substantially reduced by providing one or more eCards which are stored in a business network business directory system.

In an embodiment of the present invention, typically an eCard folder can be accessed either online or offline. The eCard folder can be downloaded to a portable device for offline access. One or more eCards can be stored in an eCard folder, creating a mini-directory or a sub-directory. The one or more eCards stored in an eCard folder can also be given a ranking based on a user defined ranking.

In an embodiment of the present invention, by utilizing one or more traditional business cards as a primary basis for obtaining one or more user or contact details, a user can provide less information data when recording their business details or contact details. The information data can then be exchanged electronically, providing greater access to one or more networking opportunities.

In an embodiment of the present invention, one or more users can belong to at least three classes that include a trial user, a registered user, or a community user. The trial user or the registered user is typically a business owner or a representative, and a community user is typically a consumer or a prospective business client. A community user may or may not have one or more associated traditional business cards, but can establish an eCard folder for collating one or more other users of interest. The community user can receive communication from one or more elected registered users in regards to one or more specials or sales. Two users can swap one or more eCards, or receive the other's one or more eCards, for storage in a private eCard folder.

In an embodiment of the present invention, a user can include one or more details associated with a third party business with one or more third party eCards to their eCard folder and include one or more traditional business cards. The user can maintain an eCard folder of one or more business contacts, even when the corresponding business is not a user. This can be further used to introduce a business to membership of the business directory system. One or more reward points can be awarded for each introduced business that becomes a user. The additional one or more eCards incorporated by a user are typically not publicly accessible until the corresponding business registers as a user, but is accessible to the user as a contact. An eCard folder can be personalized by rating one or more particular cards according to one or more user's preferences.

In one embodiment of the present invention, one or more traditional business cards provided by a user can communicate an introduction to a new business. If the new business wishes to become a user, a prepared eCard can be used to initially represent the new business. If a new business becomes a user, the server computing device can identify that the new business was previously introduced to the system by an existing user. A user that is identified as introducing a new business or a new organization can be allocated one or more reward points.

In an embodiment of the present invention, a business owner or an employee can be a user. A business may provide a membership for each employee, or could register a single membership accessible by all employees.

In an embodiment of the present invention, a user can use one or more private business records represented as one or more eCards in an eCard folder to present marketing material, or present an invitation to become a user. An inactive record developed by the user can be activated as a user. One or more private business records stored within an eCard folder can be exchanged, marketed to, introduced to a directory, or prioritized.

In an embodiment of the present invention, a directory can enable a collection of one or more business records or one or more eCards to be combined in a personal database, which can be placed in a web based environment where the one or more business records are interlinked between a plurality of users. The users enter a network, each becoming a user subscriber with intent of networking within a corporate business group.

In an embodiment of the present invention, the business network can provide an online and an offline eCard folder accessible by a user, an electronic or a digital consumer to a business or digital C2B network, an electronic or a digital business to business or digital B2B network, establish a global business network and a referral reward program where a user can earn one or more reward points for introducing or referring a new user and one or more business discount vouchers presented by a user to one or more other users.

In an embodiment of the present invention, one or more business users in the business network can trade one or more business credits they have earned as well as one or more money transactions or a combination of both as well as use their one or more credits back on card club management to get membership and other company supplied services either discounted or use credits as full outright payment for services where applicable. One or more business micropayments split for both real and internal credit currency and employs a method for utilizing a business card directory system.

For example, Fred introduced Adam, Bob, and Charlie to a business network. Bob does a transaction with Derek also in the business network and Derek is offering an incentive to one or more other users either by discount to the direct purchaser. In this example the direct purchaser is Bob, or the user who will assist them in marketing their available one or more business opportunities, discounts or other incentive offers.

In an embodiment of the present invention, the following party transactions can occur between 3 parties. The transactions include a company to a business user and visa-versa, a business user to a business user and a business user to a community user and visa-versa.

In an embodiment of the present invention, one or more party transactions occurs over 4 primary mediums in a business card directory system. The primary mediums include a face to face physical transaction, a face to face electronic transaction, an Internet electronic transaction and a transaction utilizing one or more mobile apps.

In an embodiment of the present invention, one or more users can have one or more stored credits on their one or more accounts (i.e., direct bank, Internet and mobile storage) which they can use as a currency with other one or more users. The currency can be a monetary currency and an artificial credit currency which is represented as currency only within the business network or a combination of. The one or more micropayment splits occur with users within the business network. In other words Derek's discount or incentive can be split by way of benefit both with the purchaser of the service, in this case Bob and also the main company HQ and/or Fred as the introducing user of the purchaser or all 3 parties. The negotiated micropayment or micro-benefit is split amongst multiple parties in the business network at the discretion of the company running the business network and the user giving the incentive away.

In an embodiment of the present invention, a n online social media network or FACEBOOK™ and an online business network or LINKEDIN™ have one or more users profiled online and perform one or more user to user transactions with a plurality of colored buttons provided on a home page screenshot of a business card directory system.

In an embodiment of the present invention, a home page screenshot of a business card directory system includes a photo or a profile button, a user rating button, a favorite card button that a user can save to an eCard Box, a mobile app button, a referral button that a user such as an owner can use to refer a card owner's service to one or more associates utilizing a drop down message e-mail, a swap button to allow a user to send an eCard to and from a card owner's inbox, a message button to allow a user to send a message to a card owner's inbox, a button with a link to a card owner's website so one or more users can see the card owner's website, a button with a link to a search engine or GOOGLE™ or an online map or GOGGLE MAPS™ to view one or more card owner's business locations, a button with a link to a video so a user can see an eCard owner's one or more videos or YOUTUBE™ or VIMEO® videos business presentation and other suitable videos and s a payment button so an eCard user can send one or more payments directly to a user account likely to be done by an online payment website or PAYPAL®.

In an embodiment of the present invention, there are 4 entities, a company, one or more business users, one or more sales users such as one or more promoting franchisees and one or more consumer users. When an existing business user introduces another party that becomes a paid business user, the existing business gets one or more reward points. These one or more reward points are converted into dollars at a certain value but can only be spend to purchase another business user's service. The company is a company that completes a transaction on a user's behalf to control and measure money from the transaction. One or more rewards for one or more users can also be given making one or more direct financial transactions to reward one or more personal expenditure levels within the business card directory system for rewards other than for an introduction.

In an embodiment of the present invention, a business card directory system within an online social media network or FACEBOOK™ and an online business network or LINKEDIN™ performs one or more user to user payments other than FACEBOOK™, where a user can transfer money via a third party app or PYG®. The business card directory system performs a direct user to user financial payment for one or more direct products or services. One or more direct online payment facilities are in place and mobile to mobile transactions between users can also occur and can utilize one or more currencies as well. The business card directory system includes one or more business users paying a membership fee but also paying per lead fees and paying closed business fees which can all be tracked.

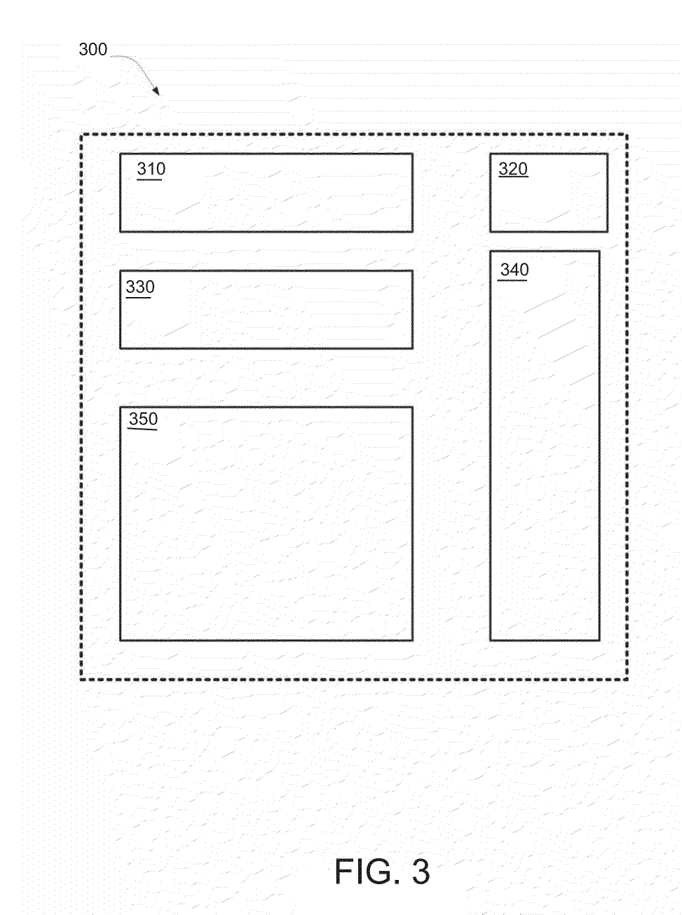

FIG. 3 illustrates a diagram of a user interface 300, in accordance with one embodiment of the present invention. The user interface 300 can include any one or more of one or more user details 310, a business logo 320, a business search interface 330, an eCard folder 340 representing one or more associated businesses of interest and one or more eCards 350 representing one or more businesses of interest typically resulting from a search query or identified from preferences recorded in a user profile. A user can market to personal business contacts, typically maintained in an eCard folder 340, utilizing permission based communication typically for marketing or introducing new users. A user can represent either a consumer or a business, enabling permission marketing or communication for business to business or B2B contacts or community to business or C2B contacts. This can provide access to introduce one or more new business users, and only businesses who register are made publically available and searchable. Businesses of interest are typically collated based on any one or more of one or more previous searches of one or more publically accessible user profiles or one or more previous searches of a private eCard folder corresponding to a user profiled interest or corresponding to selected user attributes.

Businesses of interest may be ordered either randomly, or based on a relevance ranking, or the number of other businesses introduced by the searched business. The user interface 300 can also be customized based on a user preference.

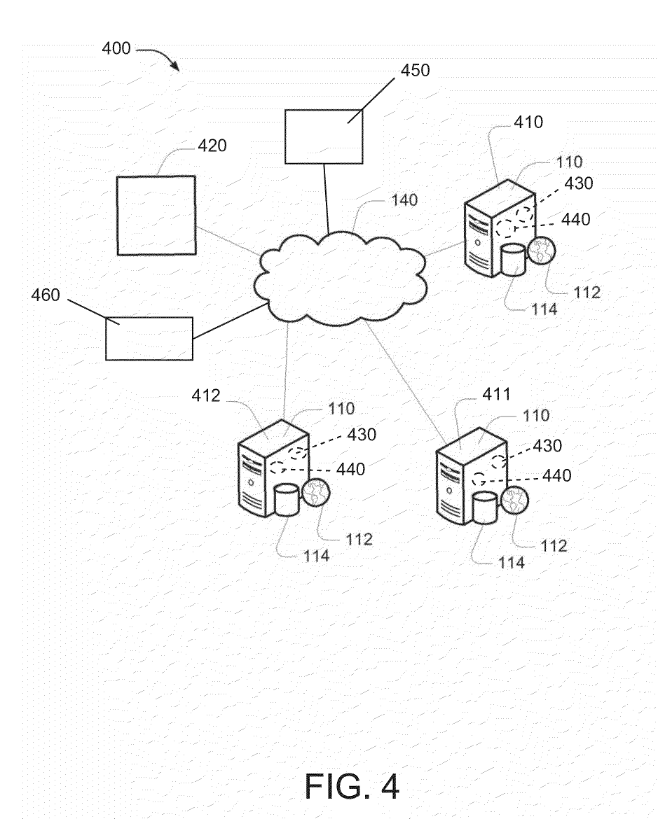

FIG. 4 illustrates a diagram of a distributed business card directory system, in accordance with one embodiment of the present invention.

FIG. 4 illustrates a business card directory system 400 to provide a user access to a data network 140 that can include one or more server computing devices 110, each with a user interface module 112 and a database 114. The one or more server computing devices 410, 411 and 412 can be distributed geographically, providing a plurality of distinct business card directories. These distinct business card directories can be in communication over a data network 140 for communicating a plurality of eCards enabling selective user's access between the business card directories.

The interface device 420 is in communication with one or more server computing devices 110 over a data network 140. A user can view one or more private eCards 430, and one or more eCards submitted by other users 440 typically made publically available. Access to an eCard folder having one or more associated eCards can be provided by the server module. Access to one or more of a plurality of distinct business card directories can be enabled on the basis of a membership level associated with one or more user records. For example, a global level user may be entitled to access any business card directory system, while a regional user may be restricted to accessing business card directories within a predetermined range. This can enable one or more local, regional and global business networks to be established. A user can be identified as any of one or more user types, including one or more users, one or more business users and one or more consumer users or one or more community user. Typically all users are registered users.

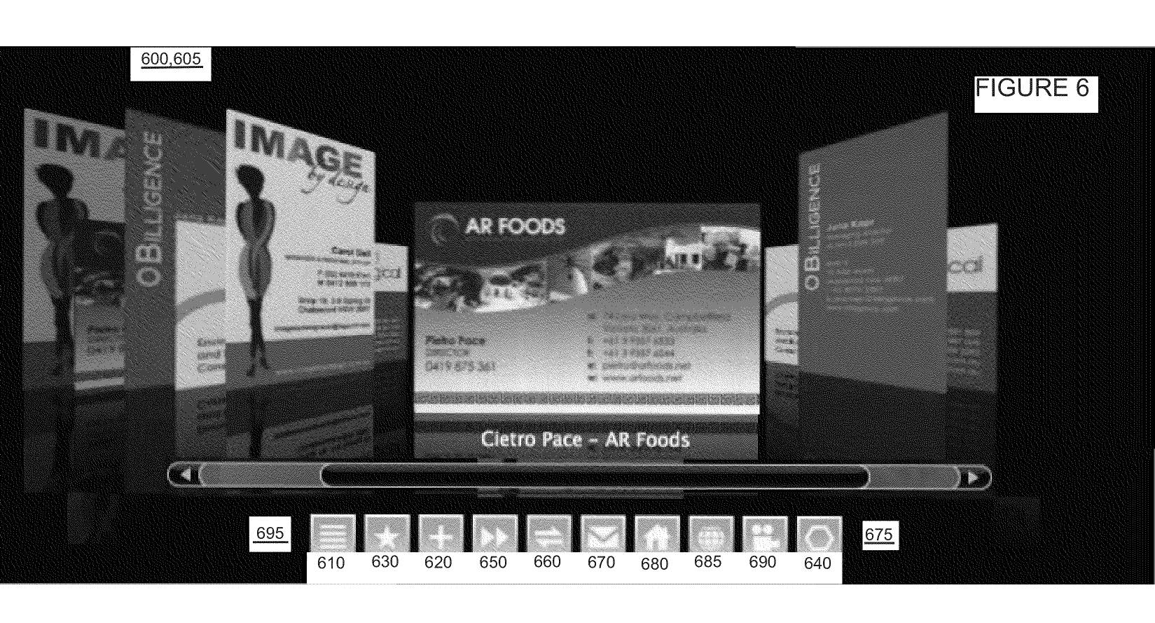

The business card directory system 400 also includes a n online social media network 450 or FACEBOOK™ and an online business network 460 or LINKEDIN™ and have one or more users profiled online and perform one or more user to user transactions with a plurality of colored buttons (FIG. 6, 610-695) provided on a home page screenshot (FIG. 6, 600) of a business card directory system 400.

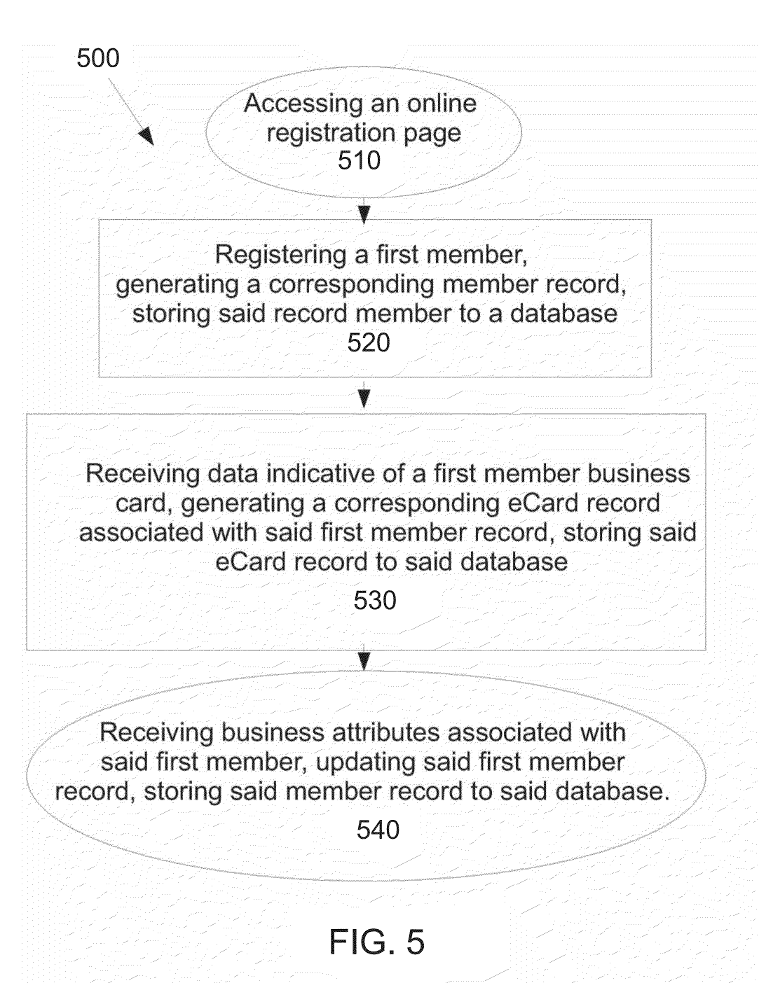

FIG. 5 illustrates a flowchart of a method for utilizing a business card directory system 500, in accordance with one embodiment of the present invention. FIG. 5 illustrates a method for utilizing a business card directory system 500 the overall method 500 includes the steps of accessing an online registration page 510 (typically after being invited by an existing user), registering (typically either as a full user, a user or a trial user) a first member, generating a corresponding member record and storing the member record to a database 520, receiving data indicative of a first member business card, generating a corresponding eCard record associated with the first member record, storing the eCard record in the database 530 and receiving business attributes associated with the first member, updating the first member record, storing the member record to the database 540. The data network can be the Internet, a local area network, a wide area network or other suitable network.

FIG. 6 illustrates a home page screenshot 600 of a business card directory website 605, in accordance with one embodiment of the present invention.

The home page screenshot 600 includes a photo or a profile button 610, a user rating button 620, a favorite card button 630 that a user can save to an eCard box, a mobile app button 640, a referral button 650 that a user such as an owner can s use to refer a card owner's service to one or more associates utilizing a drop down message e-mail, a swap button 660 to allow a user to send an eCard to and from a card owner's inbox, a message button 670 to allow a user to send a message to a card owner's inbox, a button with a link to a card owner's website 675 so one or more users can see the card owner's website, a button with a link to a search engine 680 or GOOGLE™ or one or more online maps 685 or GOGGLE MAPS™ to view one or more card owner's business locations, a button 690 with a link to a video so a user can see an eCard owner's one or more videos or YOUTUBE™ or VIMEO® videos business presentation and other suitable videos and a payment button 695 so an eCard user can send one or more payments directly to a user account likely to be done by an online payment website or PAYPAL®.

Unless specifically stated otherwise, as apparent from the following discussions, it is appreciated that throughout the specification discussions utilizing terms such as “processing”, “computing”, “calculating”, “determining” or the like, refer to the action and/or processes of a computer or computing system, or similar electronic computing device, that manipulate and/or transform data represented as physical, such as electronic quantities into other data similarly represented as physical quantities. The term processor may refer to any device or portion of a device that processes electronic data from one or more registers and/or memory to transform that electronic data into other electronic data that may be stored in one or more registers and/or one or more memory systems. A “processing system”, or equivalently: “computer”, “computing machine” or a “computing platform” may include one or more processors. Thus, one example is a typical processing system that includes one or more processors.

Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included (e.g., a liquid crystal display o r LCD or a cathode ray tube or CRT display). If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit.

The processing system in some configurations may include a sound output device, and a network interface device. The memory subsystem thus includes a computer-readable carrier medium that carries computer-readable code (e.g., software) including a set of performing instructions, when executed by one or more processors or one of more of the methods described herein.

In one or more alternative embodiments, the one or more processors operate as a standalone device or may be connected or networked to one or more other processors. In a networked deployment, the one or more processors may operate in the capacity of a server or a client machine in a server-client network environment, or as a peer machine in a peer-to-peer or distributed network environment. The one or more processors may form a personal computer o r PC, a tablet PC, a set-top box or STB, a personal digital assistant or PDA, a cellular telephone, a web appliance, a network router, switch or bridge, or any machine capable of executing a set of instructions sequential or otherwise that specify actions to be taken by that machine.

Note that while some diagrams only show a single processor and a single memory that carries the computer-readable code, those in the skilled in the art will understand that many of the components described above are included, but not explicitly shown or described in order not to obscure the inventive aspect. For example, while only a single processor “processing system” is illustrated, the term “processing system” shall also be taken to include any collection of processors that individually or jointly execute a set or multiple sets of instructions to perform any one or more of the methodologies discussed herein.

Methodologies described herein are, in one embodiment, performable by one or more processors that accept computer-readable or machine-readable code containing a set of instructions that when executed by one or more of the processors carry out at least one of the methods described herein. Any processor capable of executing a set of instructions sequential or otherwise that specify one or more actions to be taken are included. A computer-readable carrier medium may form, or be included in, a computer program product. The computer readable medium includes computer code for executing a method as herein described. Note that when the method includes several elements or several steps, no ordering of such elements is implied, unless specifically stated. The software may reside on one or more hard disks, or may also reside, completely or at least partially, within the RAM and/or within the processor during execution thereof by the computer system. Thus, the memory and the processor also constitute computer-readable carrier medium carrying computer-readable code.

Thus, one embodiment of each of the methods described herein is in the form of a computer-readable carrier medium carrying a set of instructions, such as a computer program that is for execution on one or more processors, one or more processors that are part of the device. Thus, as will be appreciated by those skilled in the art, embodiments of the present invention may be embodied as a method, a system such as a special purpose system, and a system such as a data processing system, or a computer-readable carrier medium, such as a computer program product. The computer readable carrier medium carries computer readable code including a set of instructions that when executed on one or more processors cause the one or more processors to implement a method. The present invention may take the form of a method, an entire hardware embodiment, an entire software embodiment or an embodiment combining software and hardware elements. Furthermore, the present invention may take the form of carrier medium such as a computer program product on a computer-readable storage medium carrying computer-readable program code embodied in the medium.

It will be understood that the steps of methods discussed are performed in one embodiment by one or more appropriate processors of a processing (i.e., computer) system executing instructions (i.e., computer-readable code) stored on a database or memory system. It will also be understood that the invention is not limited to any particular implementation or programming technique and that the invention may be implemented utilizing any appropriate techniques for implementing the functionality described herein. The invention is not limited to any particular programming language or operating system.

Furthermore, some of the embodiments are described herein as a method or combination of one or more elements of the method that can be implemented by a processor of a processing system or by other suitable system. Thus, the processor with the necessary instructions for carrying out such the method or an element of the method processes the method or one or more elements of the method.

Furthermore, an element described herein of a system embodiment for carrying out the function performed by the element for the purpose of carrying out the invention. The software or computer program may further be transmitted or received over a network via a network interface device. While the carrier medium is shown in an exemplary embodiment to be a single medium, the term carrier medium should be taken to include a single medium or multiple media (e.g., a centralized or distributed database, and/or associated caches and servers) that store the one or more sets of instructions. The term carrier medium shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. The term carrier medium shall include, but not be limited to, one or more solid-state memories, one or more computer products embodied in optical and magnetic media, a medium bearing a propagated signal detectable by at least one processor of one or more processors and representing a set of instructions that when executed implement a method, a carrier wave bearing a propagated signal detectable by at least one processor of the one or more processors and representing the set of instructions, the propagated signal and representing the set of instructions, and a transmission medium in a network bearing a propagated signal detectable by at least one processor of the one or more processors and representing the set of instructions.

Reference throughout this specification to “one embodiment” or “an embodiment” indicates that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the particular features, structures or characteristics may be combined in any suitable manner, as would be apparent to one of ordinary skill in the art from this disclosure, in one or more embodiments.

In the above description of exemplary embodiments of the invention, various features of the invention are sometimes grouped together in a single embodiment, figure, or description thereof for the purpose of streamlining the disclosure and aiding in the understanding of one or more of the invention. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, any claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention and form one or more different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description. Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Any one of the terms “comprising”, “comprised of” or “which comprises” is an open term that defines at least one or more elements or features that follow, but not excluding others. Thus, the term comprising, when used in the claims, should not be interpreted as being limitative to one or more elements or steps listed thereafter. For example, the scope of the expression a device comprising A and B should not be limited to devices consisting only of elements A and B. Any one of the terms including or which includes or that includes as used herein is also an open term that also defines at least the one or more elements or features that follow the term, but not excluding others. Thus, including is synonymous with and includes comprising.

Similarly, it is to be noticed that the term coupled, when used in the claims, should not be interpreted as being limitative to direct connections only. The terms coupled and connected, along with their derivatives, may be used. It should be understood that these terms are not intended as synonyms for each other. Thus, the scope of the expression a device A coupled to a device B should not be limited to one or more devices or systems a n d an output of device A is directly connected to an input of device B. It indicates that there exists a path between an output of A and an input of B which may be a path including one or more other devices or one or more methods. Coupled may be defined as two or more elements that are either in direct physical or electrical contact or that two or more elements are not in direct contact with each other but yet still co-operate or interact with each other.

As used herein, unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner. Although the invention has been described with reference to specific examples, it will be appreciated by those skilled in the art that the invention may be embodied in many other forms. It will be appreciated that an embodiment of the invention can include one or more features disclosed herein. Alternatively, an embodiment of the invention can include one or more features disclosed herein. The invention illustratively disclosed herein suitably may be practiced in the absence of any element which is not specifically disclosed therein.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A business card directory system to provide a user access to a data network, comprising:
a server computing device with a user interface module, a database and an input device, the input device inputs one or more pieces of data from one or more traditional business cards, the one or more pieces of data are transmitted over the data network to the server computing device, the data network is a selected one of the Internet, a local area network and a wide area network;
a processor system that is adaptive to receive the one or more pieces of data provided on one or more traditional business cards;
a computer program product stored on a computer usable medium that operates in combination with the processor system;
a user interface module adapted to receive the one or more pieces of data and to present a web user interface;
a referral rewards program that allows the user to gain one or more reward points based on one or more new users joining the business card directory system; and
an online social media network and an online business network.

2. The business card directory system according to claim 1, wherein the input device presents the one or more traditional business cards from which the one or more pieces of data are generated which is submitted to the server computing device over a data network.

3. The business card directory system according to claim 2, wherein the one or more traditional business cards and the one or more pieces of data are scanned into the server processor to be swapped, exchanged and stored as desired by the user.

4. The business card directory system according to claim 1, wherein the server computing device generates a user ecard from the data provided on the one or more traditional business cards that are stored in the database.

5. The business card directory system according to claim 4, wherein the user ecard is made available to match the user to one or more searched business services.

6. The business card directory system according to claim 1, wherein the business card directory system includes a private access storage memory and a public storage memory that allows the user to separately store and prioritize the one or more pieces of data.

7. The business card directory system according to claim 1, wherein the ecard is provided restricted availability to the user associated with presenting a corresponding one or more traditional business cards.

8. The business card directory system according to claim 1, wherein the ecards generated by the user that is associated with a third party are privately accessible to a third party user.

9. The business card directory system according to claim 8, wherein the generated ecards are maintained in a virtual ecard folder.

10. The business card directory system according to claim 1, wherein the ecard folder has offline access to an ecard folder provided by the mobile interface device.

11. The business card directory system according to claim 1, wherein the server processor is adapted to receive the one or more pieces of data provided on the one or more traditional business cards.

12. The business card directory system according to claim 1, wherein the business card directory system includes a business card directory website with a photo or a profile button, a user rating button, a favorite card button, a mobile app button, a referral button, a drop down message e-mail, a swap button, a message button, a button with a link to a card owner's website, a button with a link to a search engine, one or more online maps, a button with a link to a video and a payment button.

13. A method for utilizing a business card directory system, comprising:
accessing an online registration page;
registering a first member, generating a corresponding member record, storing the member record to a database;
receiving data indicative of a first member business card, generating a corresponding eCard record associated with the first member record, storing the eCard record to the database; and
receiving business attributes associated with the first member, updating the first member record, storing the member record to the database.

14. The method for utilizing according to claim 13, wherein said the data network can be the Internet, a local area network, a wide area network or other suitable network.

15. The method for utilizing according to claim 13, wherein the method for utilizing provides a computer program product stored on a computer usable medium.

16. The method for utilizing according to claim 15, wherein the computer program product is adapted to provide the business card directory system.

17. The method for utilizing according to claim 16, wherein the computer program product stored on the computer usable medium is adapted to provide a user access interface for a processor.

18. The method for utilizing according to claim 17, wherein the processor is adapted to receive a one or more pieces of data provided on one or more traditional business cards.

19. The method for utilizing according to claim 18, wherein the processor is coupleable to a database having one or more user records associated with the one or more pieces of data.

20. The method for utilizing according to claim 13, wherein the method for utilizing includes a computer readable program to provide the business card directory system.
